(19) United States
(12) Patent Application Publication
(10) Pub. No.: US 2026/0298844 A1
(43) Pub. Date: Oct. 1, 2026

(54) Stereo Augmented Radiography

(71) Applicant: James Edward Prindiville, Lincoln, CA (US)

(72) Inventor: James Edward Prindiville, Lincoln, CA (US)

(21) Appl. No.: 19/671,596

(22) Filed: May 8, 2026

Related U.S. Application Data
(63) Continuation-in-part of application No. 19/574,776, filed on Mar. 23, 2026, now abandoned.
(60) Provisional application No. 63/781,809, filed on Apr. 1, 2025.

(51) Int. Cl. G01N 23/04; G01N 23/083; G06T 5/80; G06T 7/00; G06T 7/593; G06T 7/73

(52) U.S. Cl. CPC G01N 23/04; G01N 23/083; G06T 5/80; G06T 7/0004; G06T 7/593; G06T 7/74; G01N 2223/303; G01N 2223/401; G06T 2207/10012; G06T 2207/10116; G06T 2207/30108

(57) ABSTRACT

The present invention relates to radiographic inspection systems and methods for determining three-dimensional positional information and magnification-compensated dimensional measurements from projection-based stereo radiographic images. A stereo image pair is acquired using a penetrating radiation source and at least one detector, wherein relative lateral displacement between imaging components provides separated perspectives. Inspection geometry parameters, including geometric relationships among the source, object, and detector, are determined using a calibration structure or image-based estimation. Corresponding features between the stereo images are identified and depth location is computed using calibrated disparity. Effective pixel pitch is determined based on feature depth to compensate for geometric magnification, enabling calculation of true physical feature dimensions. The system may generate corrected two-dimensional radiographic images and structured stereo reference overlays for stereo images. Embodiments include stationary source configurations, linear detector array systems, automated defect classification, two-image presentation and inspection decision outputs without requiring volumetric computed tomography reconstruction.

### PRIORITY

This application claims priority for the U.S. provisional application Ser. No. 63/781,809 filed Apr. 1, 2025.

### FIELD OF THE INVENTION

The present invention generally relates to non-destructive testing and digital radiographic inspection systems and methods, as well as the use of these systems. More specifically, it relates to software-driven, computer-assisted, and/or digitally processed stereo radiography systems and methods that employ digital detectors, automated image analysis, and calibrated geometric processing to determine three-dimensional positional and dimensional information of internal features within an object under inspection from projection-based radiographic image data.

### INCORPORATION BY REFERENCE

All publications, patents, and patent applications mentioned in this specification are herein incorporated by reference in their entirety to the same extent as if each publication or patent application were specifically and individually indicated to be incorporated by reference.

### BACKGROUND OF THE INVENTION

Radiographic inspection techniques, including film-based radiography and digital radiography, generate projection images representing attenuation of penetrating radiation along paths extending from a radiation source to an imaging receptor. Such projection images are commonly referred to as shadowgraph images and provide two-dimensional (2-D) representations of internal structures within an inspected object.

While projection radiography is widely used for detection of internal features such as discontinuities, inclusions, voids, weld defects, or structural irregularities, conventional 2-D projection images do not inherently provide direct positional information along the axis extending between the radiation source and the imaging receptor (i.e., depth information).

In projection-based radiography, the apparent size of a feature within an image depends on both the true physical size of the feature and its position along the source-to-detector axis. Because of geometric divergence of the radiation beam, effective image pixel pitch varies as a function of depth. Features positioned closer to the radiation source may appear larger than equivalent features positioned closer to the detector. As a result, apparent feature size in a projection image can differ from true physical size.

Although geometric magnification effects are understood in radiographic practice, conventional radiographic workflows typically do not compute depth-specific effective pixel pitch for individual indications within a projection image.

Stereo radiographic imaging techniques have been used to provide three-dimensional perspective information by acquiring two radiographic images from laterally separated viewpoints. When geometric relationships among the radiation source, object, and detector are known or determined, disparity between corresponding features in a stereo image pair may be used to estimate depth location relative to a reference frame.

Stereo implementations involve acquiring stereo paired images with relative displacement between imaging components to create laterally separated perspectives. Acquisition of stereo image pairs has traditional involved repositioning the heavy radiation source, maintaining geometric repeatability, or doubling image exposure time which have limited widespread adoption of stereo radiography in some industrial contexts.

In more recent decades, computed tomography (CT) systems have gained increased use in certain inspection environments due to their ability to reconstruct volumetric datasets. CT systems typically acquire a series of projections over multiple angles and perform computational reconstruction to generate volumetric representations.

While CT can provide detailed volumetric information, CT acquisition and reconstruction processes may involve rotational mechanics, extended acquisition time, and generation of large datasets requiring substantial computational resources and interpretation effort. For certain inspection scenarios, projection-based techniques capable of providing positional information without full volumetric reconstruction may offer workflow advantages.

Advances in digital detectors, image processing, and computational capability have significantly enhanced radiographic inspection systems. Digital radiographic techniques often employ frame averaging or other processing methods to improve signal-to-noise ratio (SNR). Stereo image pairs may be acquired using digital techniques while maintaining comparable SNR to conventional averaged 2-D images, with minimal increase in inspection time.

However, integration of calibrated stereo processing, structured geometric parameter determination, automated disparity computation, and magnification-compensated dimensional analysis into digital radiographic workflows has historically been limited.

Additionally, although stereo visualization devices such as stereo monitors, virtual reality headsets, and anaglyph systems are available, many radiographic interpreters continue to perform interpretation on conventional 2-D displays. As such, systems that provide depth-derived information in formats usable on both stereo and non-stereo displays are advantageous.

Human perception of depth in stereo imagery may be enhanced through structured visual cues. In graphical arts, horizon lines and vanishing points are used to convey depth relationships in 2-D renderings. Analogously, computer-generated three-dimensional reference overlays may assist visual registration of stereo radiographic image pairs.

Despite advances in computer graphics and image processing, structured stereo reference overlays dynamically derived from inspection geometry parameters have not been widely integrated into radiographic inspection workflows.

Linear detector array (LDA) systems are used in certain inspection configurations, including stationary-source scanning systems in which an object is translated relative to the detector. In such systems, effective pixel pitch characteristics may differ along orthogonal axes. For example, pixel pitch along the detector array axis may be influenced by geometric magnification, whereas pixel pitch along the scan direction may be determined by sampling rate and translation speed.

Conventional workflows may not provide depth-dependent normalization or axis-specific rescaling of indications within LDA-generated projection images.

Accordingly, there remains a need for radiographic systems and methods that: determine inspection geometry parameters in a structured and repeatable manner; compute depth location of identified features using calibrated disparity; calculate depth-dependent effective pixel pitch; provide magnification-compensated dimensional measurements; support multiple stereo acquisition geometries, including stationary source configurations; generate visualization aids derived from inspection geometry parameters; provide usable outputs for both stereo-enabled and conventional 2-D viewing environments; and deliver positional information without requiring full volumetric reconstruction.

The present invention addresses these needs by applying modern computational processing, geometric calibration techniques, digital imaging capabilities, and optional artificial intelligence-based analysis to stereo radiographic inspection systems. The present invention further includes computer simulations demonstrating stereo image formation, depth computation, geometric magnification effects, and dimensional correction. Simulated stereo datasets are presented as side-by-side stereo pairs and as anaglyph images to illustrate three-dimensional perception and disparity-based depth relationships. Visualization of such stereo representations in three dimensions may utilize stereo presentation devices including stereo monitors, virtual reality headsets, or anaglyph viewing systems. The simulation results demonstrate that calibrated stereo processing can provide reliable three-dimensional positional information and dimensional normalization using projection-based radiographic data.

### SUMMARY OF THE INVENTION

The following listing of embodiments is a non-limiting statement of various aspects of the invention. Other aspects and variations will be evident in light of the entire disclosure.

The present invention provides a stereo augmented radiography system and method that generates three-dimensional positional and dimensional information from stereo radiographic image pairs acquired using digital detectors and a stationary radiation source or a shifted radiation source. The present invention is primarily implemented as a software-driven inspection platform operating on acquired radiographic data.

Further, the present invention provides systems and methods that use an x-ray or gamma ray source, digital radiographic sensors, manipulators, stereo-pair images of items under inspection, stereo imaging monitors/viewers, stereo-pair reference frame overlays (to assist with visual 3-D registration of the stereo-pair images), a setup registration device and AI for identification of items of interest coupled with computer programs for calculating the location of interest items in three dimensions and sizing of interest items independent of radiographic geometric magnification.

An aspect of the present invention involves acquiring stereo radiographic image pairs without repositioning the radiation source by instead shifting the object under inspection and the detector together, or by employing two stationary linear detector arrays with controlled object translation. These acquisition techniques reduce mechanical complexity and improve repeatability and inspection throughput.

In another aspect of the present invention, it provides an automated image analysis which is used to identify corresponding features in stereo image pairs. Artificial intelligence techniques are optionally used but are not required. Feature correspondence is optionally and alternatively determined using rule-based matching, pattern recognition, or deterministic image processing methods.

In another aspect of the present invention, the system calculates three-dimensional coordinates for each identified feature by computing depth from image disparity and deriving lateral positions using known source-to-detector distance, source-to-object distance, and beam normal location.

In another aspect of the present invention, a setup registration device (SRD) having known geometry is used to determine and verify inspection geometry parameters, including distances and beam normal location, enabling accurate and repeatable depth calculations. In alternative embodiments, equivalent calibration parameters is optionally determined using image-only calibration techniques. The SRD is reusable across multiple inspections.

In another aspect of the present invention, stereo reference frames (SRFs) are dynamically generated for each stereo inspection and overlaid on stereo images to provide visual depth cues and spatial context for stereo visualization. SRFs are used only for stereo visualization and are not applied to non-stereo two-dimensional displays.

In another aspect of the present invention, effective image pixel pitch is calculated as a function of feature depth, allowing geometric magnification to be compensated. This enables accurate sizing of features independent of their position along the source-to-detector axis. Corrected two-dimensional images may be generated in which all features are normalized to a common scale. The corrected images are optionally used for visual display and automated acceptance or rejection decisions.

Other objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The accompanying drawings are included to provide a further understanding of the invention and are incorporated in and constitute a part of the present invention and, together with the description, serve to explain the principle of the invention.

### In the Drawings,

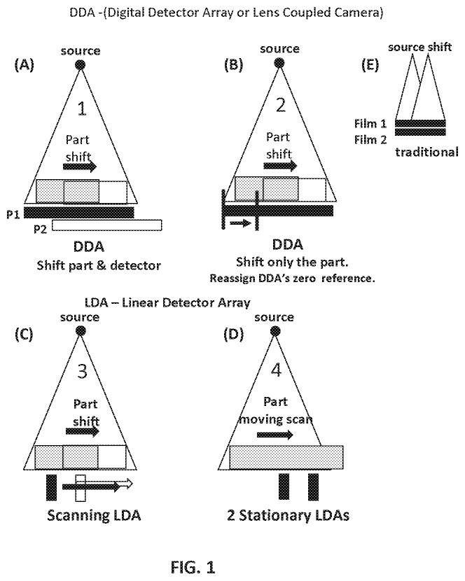

FIG. 1 illustrates an embodiment of the present invention and provides five stereo image acquisition options, namely the ones as disclosed in the present invention illustrated in panels (A) to (D) labelled as 1 to 4, and the traditional means illustrated in panel (E).

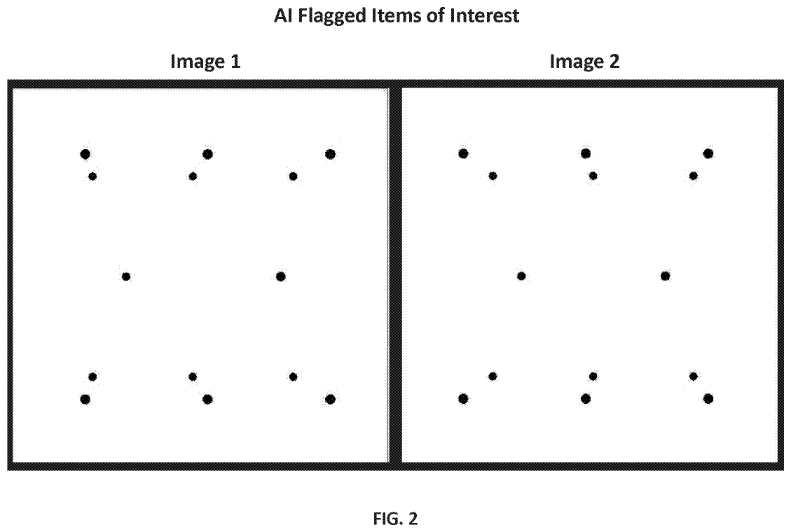

FIG. 2 illustrates an embodiment of the present invention and provides an illustration showing computer flagged items of interest from a simulated stereo pair radiographic image.

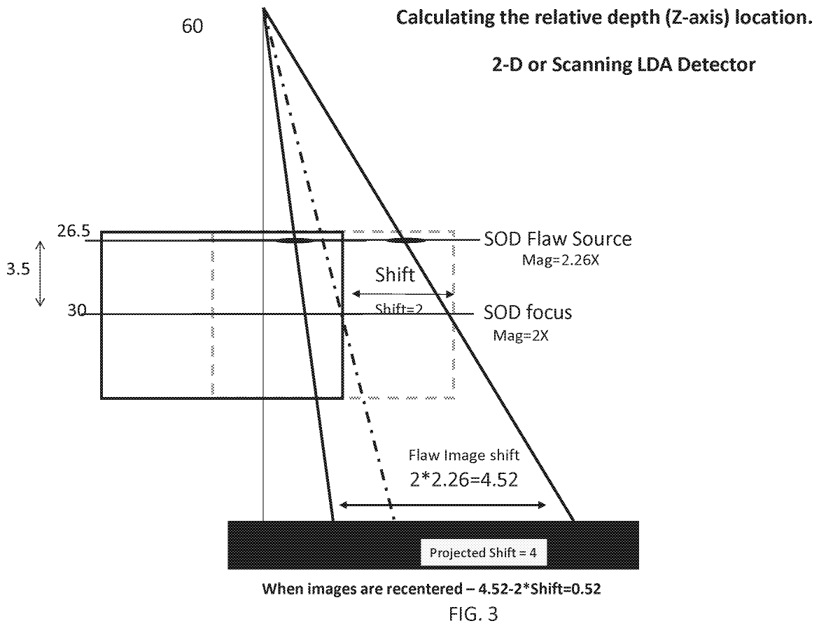

FIG. 3 illustrates an embodiment of the present invention and provides an illustration illustrating the calculation for the depth for an item of interest (e.g. flaw) identified in a stereo radiograph acquired from a 2-D detector or a scanning linear detector array (LDA).

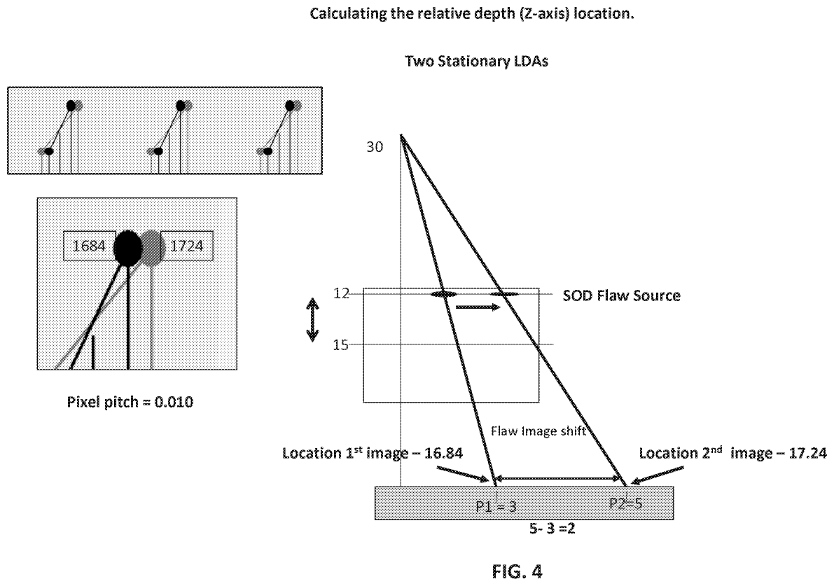

FIG. 4 illustrates an embodiment of the present invention and provides an illustration illustrating the calculation for depth for an item of interest (e.g. flaw) identified in a stereo radiograph acquired from two stationary LDAs and a moving part.

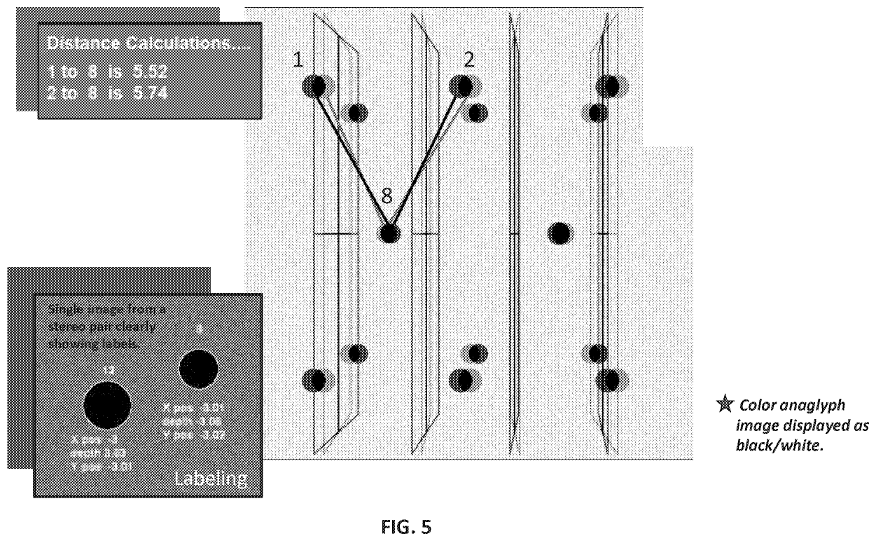

FIG. 5 illustrates an embodiment of the present invention and provides an illustration illustrating the ability to acquire and display 3-D positional information for items of interest (e.g. flaws) and also illustrates the ability to calculate distances between items of interest and show 3-D connecting lines.

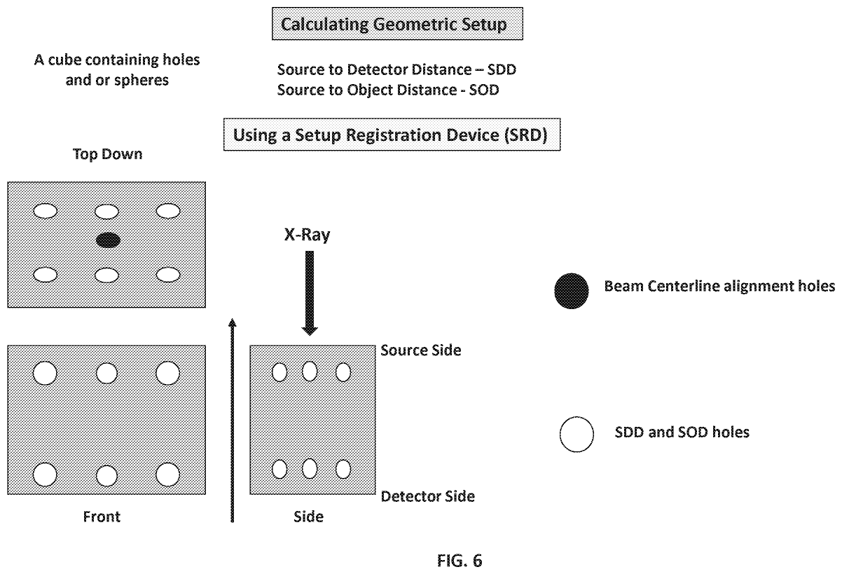

FIG. 6 illustrates an embodiment of the present invention and provides a sketch for a device, Setup Registration Device (SRD) that can be used to verify the setup and relationships between the equipment used for acquiring the stereo images (distances and beam normal position).

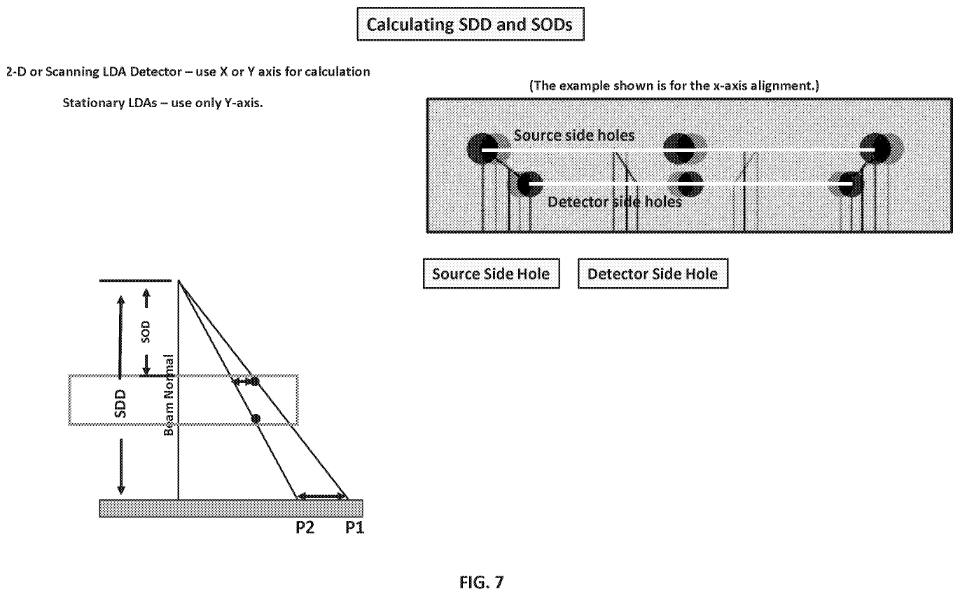

FIG. 7 illustrates an embodiment of the present invention and provides an illustration illustrating how the Setup Registration Device (SRD) is used to verify the distances between the x-ray source and detector and the source and part being radiographed for stereo image acquisitions using a 2-D detector, scanning LDA or two stationary LDAs.

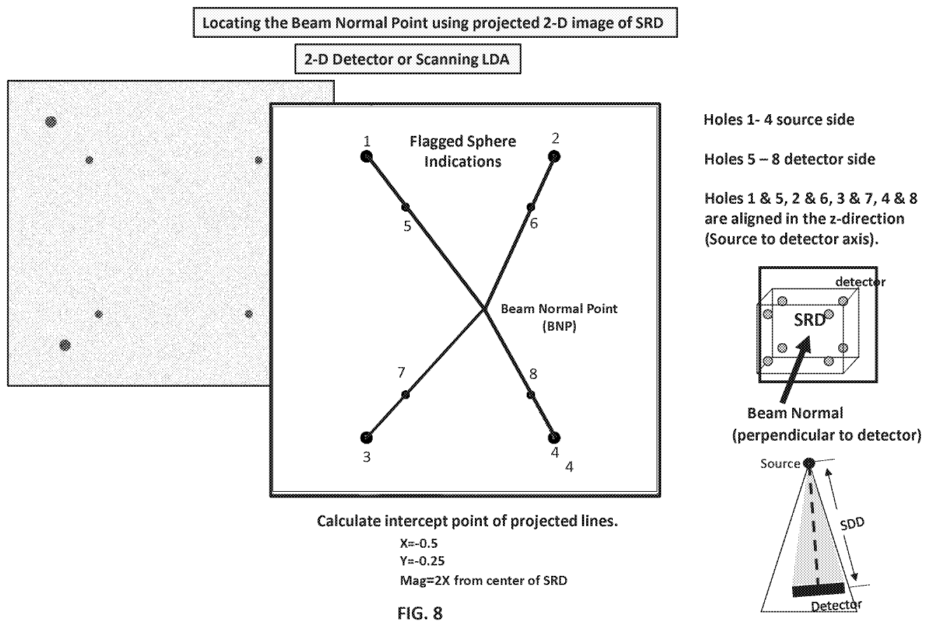

FIG. 8 illustrates an embodiment of the present invention and provides an illustration illustrating how the Setup Registration Device (SRD) is used to verify the x-ray beam centerline for stereo image acquisitions using two stationary LDAs and a moving part.

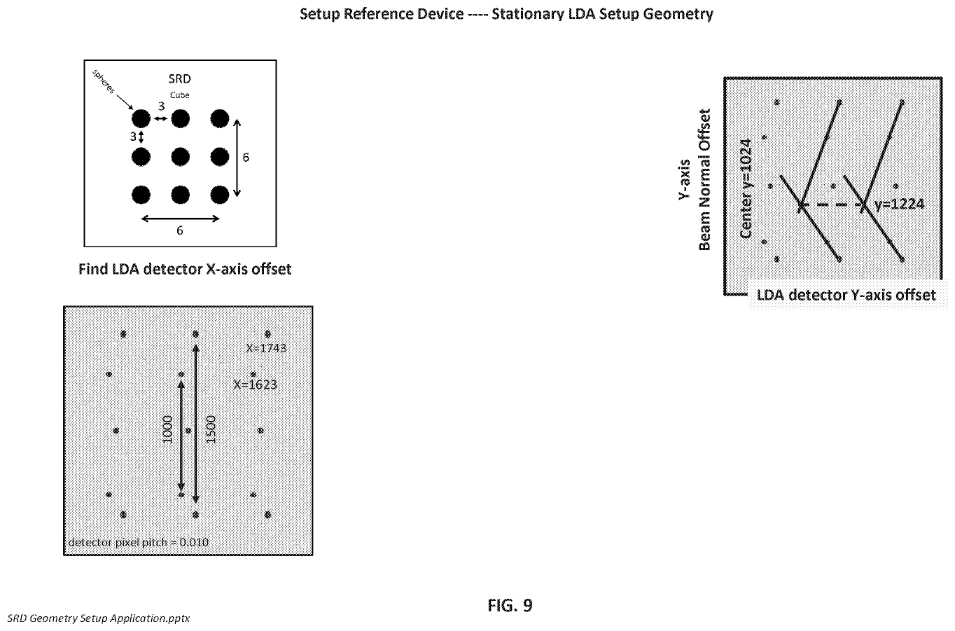

FIG. 9 illustrates an embodiment of the present invention and provides an illustration illustrating an alternative process for acquiring the x-ray beam normal position location using a 2-D projected radiographic image of a Setup Registration Device (SRD).

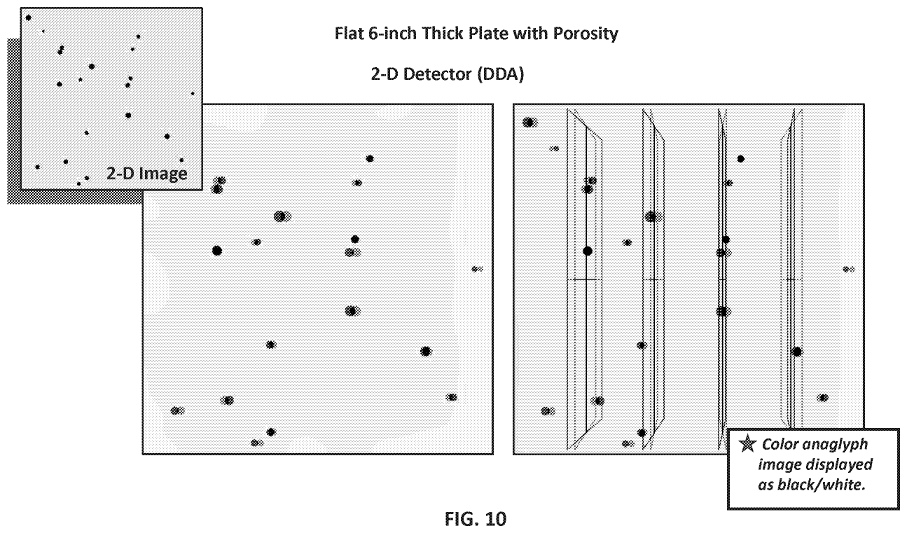

FIG. 10 illustrates an embodiment of the present invention and provides an illustration showing two computer simulated stereo radiographic images (anaglyphs) acquired from a flat 2-D digital detector array, one without and one with a Stereo Reference Frame (SRF), of a flat plate with internal features. Further, a conventional 2-D projected radiograph is also shown.

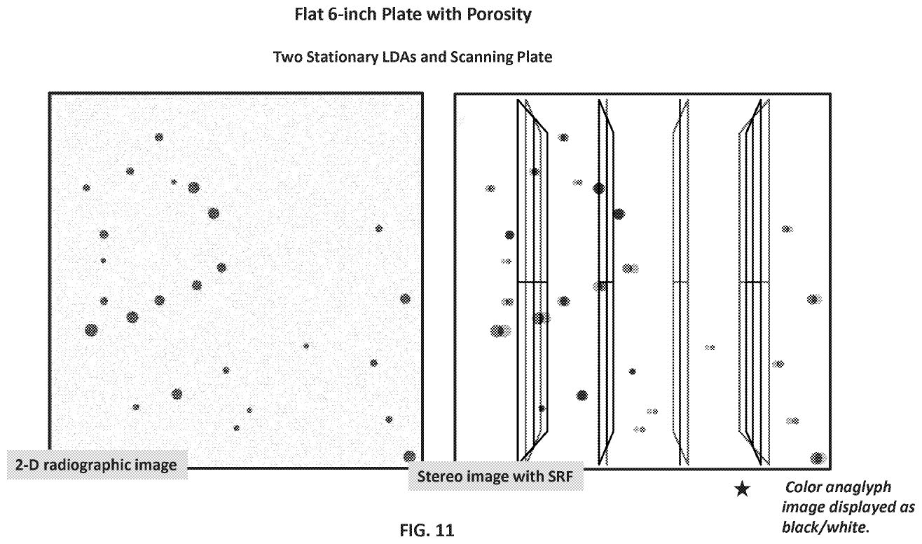

FIG. 11 illustrates an embodiment of the present invention and provides an illustration showing two computer simulated radiographic images acquired from two parallel LDA detectors one a stereo radiographic image with a Stereo Reference Frame (SRF, anaglyph) and a conventional 2-D radiographic image, of a flat plate with internal features.

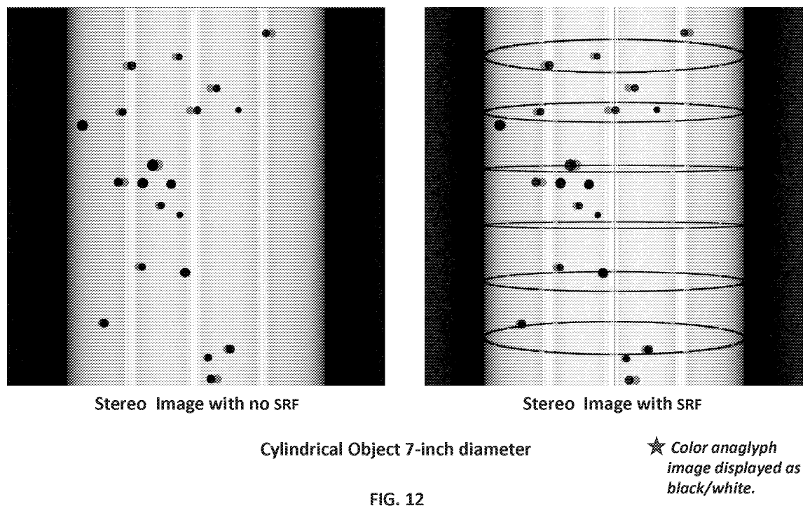

FIG. 12 illustrates an embodiment of the present invention and provides an illustration showing two computer simulated stereo radiographic images (anaglyphs), one without and one with a Stereo Reference Frame (SRF), of a vertically oriented cylinder with internal features.

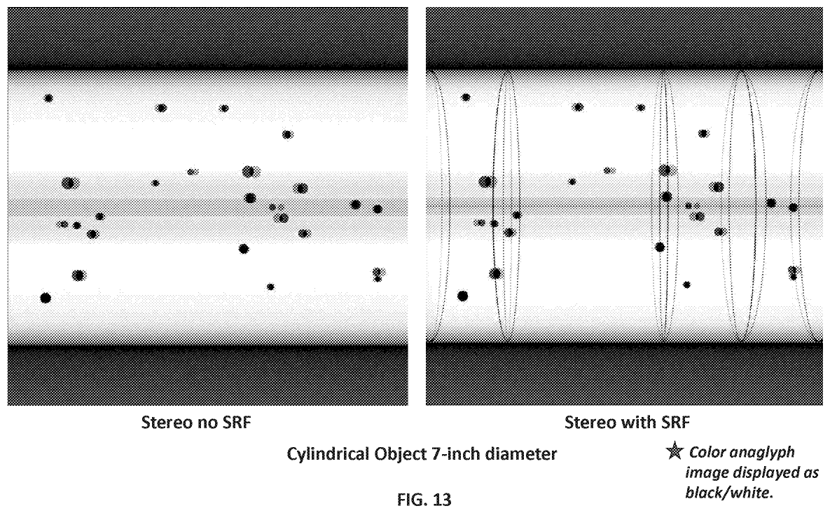

FIG. 13 illustrates an embodiment of the present invention and provides an illustration showing two computer simulated stereo radiographic images (anaglyphs), one without and one with a Stereo Reference Frame (SRF), of a horizontally oriented cylinder with internal features.

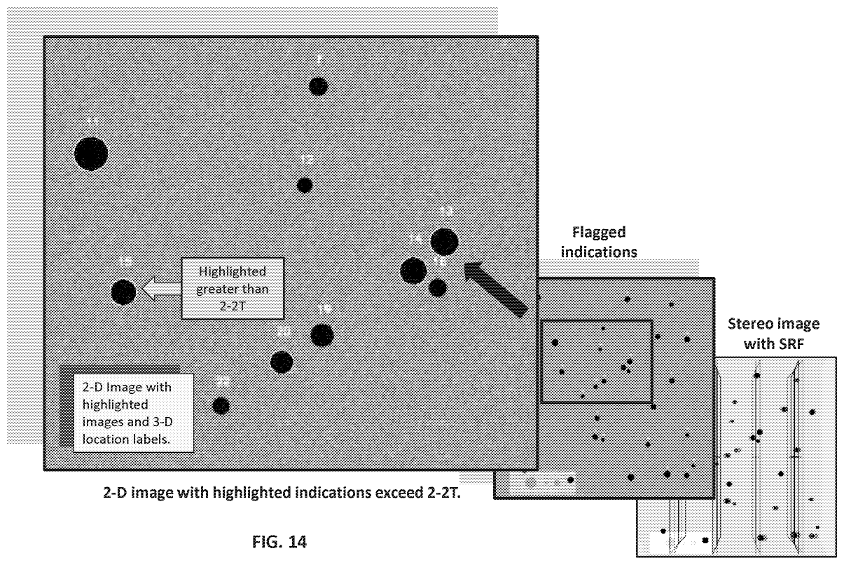

FIG. 14 illustrates an embodiment of the present invention and provides an illustration showing a computer simulated 2-D projected radiograph of a flat plate with the 3-D dimensional locations identified for each indication. It also highlights each indication that has an actual diameter (not projected image size) that is equal to or greater than the 2-2T penetrometer hole (see white ring). Further, a stereo image is also shown with 3-D location information and highlights.

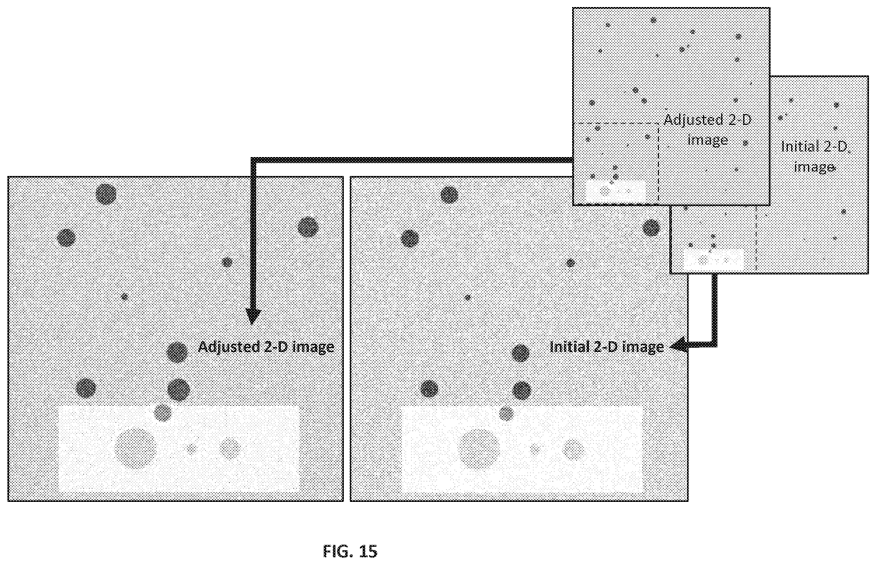

FIG. 15 illustrates an embodiment of the present invention and provides an illustration showing a computer simulated 2-D projected radiograph of a flat plate with all indications sized to the same image effective pixel pitch (same geometric magnification factor) along with the initial image and indications prior to pixel pitch adjustments.

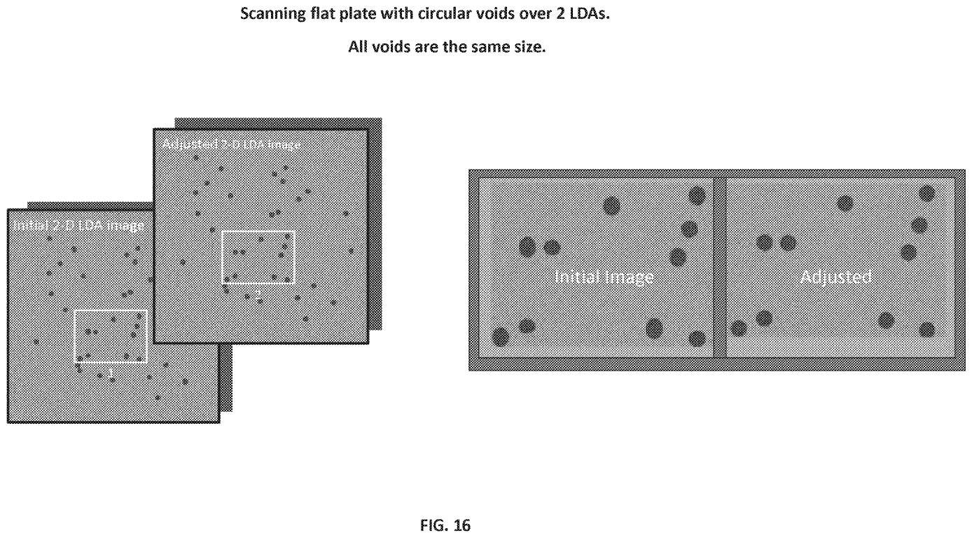

FIG. 16 illustrates an embodiment of the present invention and provides an illustration showing a computer simulated Linear Diode Array (LDA) image of a flat plate containing circular voids all of equal size. The initial 2-D projected LDA image shows voids of various sizes and shapes. A second, adjusted, image is presented which rescaled the images of the voids based on their depth and the LDA scan parameters. The adjusted image shows that the shape and size of all the void images are the same after adjustment for their position relative to the source and detector (depth).

### DETAILED DESCRIPTION OF THE INVENTION

Detailed embodiments of the present invention are disclosed herein. However, it is to be understood that the disclosed embodiments are merely exemplary of the present invention, which may be embodied in various systems. Therefore, specific details disclosed herein are not to be interpreted as limiting, but rather as a basis for teaching one skilled in the art to variously practice the present invention.

All illustrations of the drawings are for the purpose of describing selected versions of the present invention and are not intended to limit the scope of the present invention. All illustrations of the drawings are for the purpose of describing selected versions of the present invention and are not intended to limit the scope of the present invention. All images presented in this paper are computer generated.

Unless defined otherwise, all technical and scientific terms and any acronyms used herein have the same meanings as commonly understood by one of ordinary skill in the art in the field of the invention. Although any methods and materials similar or equivalent to those described herein can be used in the practice of the present invention, the exemplary methods, devices, and materials are described herein.

Although any methods and materials similar or equivalent to those described herein can be used in the practice of the present invention, the exemplary methods, devices, and materials are described herein. For the present disclosure, the following terms are defined below. Additional definitions are set forth throughout this disclosure.

As used herein, the terms “comprises,” “comprising,” “includes,” “including,” “has,” “having,” “contains”, “containing,” “characterized by,” or any other variation thereof, are intended to encompass a non-exclusive inclusion, subject to any limitation explicitly indicated otherwise, of the recited components. For example, a microbe, a microbial formulation, a pharmaceutical composition, and/or a method that “comprises” a list of elements (e.g., components, features, or steps) is not necessarily limited to only those elements (or components or steps), but may include other elements (or components or steps) not expressly listed or inherent to the microbe, microbial formulation, pharmaceutical composition and/or method. Reference throughout this specification to “one embodiment,” “an embodiment,” “a particular embodiment,” “a related embodiment,” “a certain embodiment,” “an additional embodiment,” or “a further embodiment” or combinations thereof means that a particular feature, structure or characteristic described in connection with the embodiment is included in at least one embodiment of the present invention. Thus, the appearances of the foregoing phrases in various places throughout this specification are not necessarily all referring to the same embodiment. Furthermore, the particular features, structures, or characteristics may be combined in any suitable manner in one or more embodiments.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As used herein, the term “and/or” when used in a list of two or more items, means that any one of the listed items can be employed by itself or in combination with any one or more of the listed items. For example, the expression “A and/or B” is intended to mean either or both of A and B, i.e., A alone, B alone, or A and B in combination. The expression “A, B, and/or C” is intended to mean A alone, B alone, C alone, A and B in combination, A and C in combination, B and C in combination, or A, B, and C in combination.

As used herein, the term “about” refers to a rough estimate of the number or amount of the quantity referred to and is in the vicinity of the actual number or figure immediately following said term, where the actual number or figure or amount could be slightly higher or lower.

As mentioned before, radiographic inspection is widely used in industrial, aerospace, energy, defense, additive manufacturing, and pipeline applications to detect internal defects such as voids, cracks, inclusions, porosity, lack of fusion, and dimensional irregularities within manufactured components.

As discussed above, today's radiographic inspections have all but eliminated the use of film in favor of digital x-ray detectors. The processes used are two-dimensional (2-D or 2D, used interchangeably herein) digital radiography (DR) and three-dimensional (3-D or 3D, used interchangeably herein) data acquisition with computed tomography (CT). Such traditional industrial radiography employs a penetrating radiation source, such as an X-ray source or gamma source, and a detector positioned opposite the source, where a single 2-D projection image is produced. While effective for detecting contrast variations caused by internal discontinuities, conventional 2-D radiography suffers from inherent limitations, including depth information is not directly available; apparent feature size varies due to geometric magnification; overlapping structures obscure interpretation; and true physical defect dimensions cannot be reliably extracted without assumptions.

With the advent of digital radiography (DR), digital flat-panel detectors and linear detector arrays replaced film, enabling improved dynamic range, image processing, and storage. However, digital radiography remains fundamentally a projection-based modality. A radiographic image represents a two-dimensional integration of attenuation along the beam path. As a result: a defect located near the source appears larger than the same defect located near the detector; pixel size does not directly correspond to physical dimensions without geometric correction; and/or depth location of a feature within a part cannot be determined from a single projection. Even with digital processing enhancements, conventional DR does not inherently provide calibrated three-dimensional positional information.

To overcome projection ambiguity, computed tomography (CT) has become widely used in high-precision inspection environments. Industrial CT systems reconstruct volumetric datasets by acquiring hundreds or thousands of radiographic projections at different angular positions around the object. CT provides: voxel-based volumetric reconstruction; accurate three-dimensional geometry; true dimensional metrology capability; internal slice visualization; industrial CT is widely deployed in: aerospace component inspection, additive manufacturing validation, medical device manufacturing, research laboratories. However, CT systems suffer from significant drawbacks, including: (a) CT systems are substantially more expensive than standard radiography systems. (b) Rotational acquisition and reconstruction significantly increase inspection time. (c) Reconstruction algorithms are computationally intensive. (d) Object stability during rotation is critical. (e) CT is not well suited for high-speed inline production environments. (f) Repeated projections increase exposure resulting in radiation dose considerations. For industries such as pipeline inspection, aerospace production lines, and additive manufacturing quality assurance, CT is often impractical for high-throughput or field deployment scenarios.

On the other hand, stereo radiography techniques have been explored historically in medical imaging and non-destructive testing. Classical stereo systems typically: acquire two images from slightly different source positions; translate the X-ray source between exposures; or use dual sources separated by a baseline. Such systems enable stereoscopic viewing but have not been widely adopted in industrial NDT environments due to practical limitations including: mechanical complexity in moving radiation sources; calibration instability; limited integration with digital dimensional metrology; and lack of automated depth and magnification correction workflows.

In many conventional stereo radiography systems, stereoscopic interpretation relies primarily on human visual perception rather than calibrated geometric depth computation. Where depth reconstruction algorithms have been applied, they are often not tightly integrated with inspection geometry calibration sufficient to provide reliable true-size dimensional metrology. Furthermore, prior stereo systems generally do not address geometric magnification compensation in a feature-specific manner tied to calibrated source-object-detector geometry.

Digital radiography systems commonly employ detector calibration for purposes such as: flat-field correction; gain correction; offset correction; or pixel defect compensation. Such calibration methods improve image quality but do not provide full geometric characterization of source-object-detector relationships nor beam normal point location necessary for precise three-dimensional position computation.

Similarly, machine vision stereo matching techniques are known in optical imaging fields. However, optical stereo systems operate under fundamentally different geometric and attenuation conditions compared to penetrating radiation systems. Optical stereo matching algorithms are not directly transferable to radiographic inspection without accounting for radiographic projection physics and magnification geometry.

However, the industry has essentially ignored the stereo radiographic process, partly because in the past, stereo radiography was difficult to implement, and/or the use of film as a detector was a deterrent and the requirement to move the source and carefully reposition it was problematic. Even though, modern stereo radiography has new resources, namely, digital detectors, computer-controlled part positioning (e.g. linear stage), artificial intelligence (AI), computer image and data processing, etc., still, any recent technology advancements in the field of the present invention for the industry have all but exclusively concentrated on CT and neglected stereo radiography.

Accordingly, there remains a significant technological gap between: low-cost, high-throughput digital radiography (fast but 2D only), and high-accuracy computed tomography (3D but expensive and slow). Industries including aerospace, additive manufacturing, pipeline inspection, energy infrastructure, and defense require: accurate internal defect dimensional measurement; true physical size determination independent of magnification; depth localization within components; high inspection throughput; compatibility with existing radiographic equipment; and reduced cost relative to CT. Conventional systems do not adequately satisfy this combination of requirements.

The present invention addresses the above gaps and needs in the art by disclosing that there are significant improvements that can be applied to stereo radiography that can be employed in the industry. Stereo radiography, provides additional information when compared to standard 2D radiography and is employable in lieu of CT for many applications, reducing cost. The present invention provides a stereo radiographic inspection process that is employed to identify items of interest (e.g. flaws) in a part, provide 3-D positional information and display the information in 2-D or 3-D aligned with the items of interest, measure the distance between items of interest and display it, and provide a 3-D stereo pair image with a 3-D reference frame or Stereo Reference Frame (SRF) to aid the viewer with proper depth registration for the stereo image. The present invention also provides a Setup Registration Device (SRD) that can be used to assist with the alignment and/or validate the equipment alignment that is required to establish 3-D data for items of interest.

The present invention additionally presents several applications where stereo augmented radiography can be used to enhance 2-D radiographic images and/or provide additional information for an inspector reviewing a standard 2-D radiography.

The present invention provides a calibrated stereo radiographic inspection framework that bridges the technological gap between projection radiography and full computed tomography.

Stationary source stereo acquisition: Unlike many prior stereo systems that reposition the radiation source, the present invention maintains a stationary penetrating radiation source and generates stereo disparity using: object and detector lateral displacement; or dual stationary linear detector arrays with controlled object translation. Maintaining a stationary source improves geometric stability, simplifies mechanical implementation, and enhances repeatability.

In motion, part translation, stereo acquisition: Unlike many prior stereo systems that acquire images from a stationary part, the present invention translates the part over two stationary linear detector arrays. This also allows for stereo image acquisition of large items.

Integrated geometric calibration via Setup Registration Device (SRD): The invention introduces a structured calibration methodology using a setup registration device having known spatial features. This enables determination of: source-to-detector distance; source-to-object distance; and beam normal location on the detector plane. Such calibrated geometry is used directly in-depth computation and magnification compensation, enabling physically meaningful three-dimensional positioning without volumetric CT reconstruction.

Depth computation without volumetric reconstruction: Rather than reconstructing a full voxel volume as in CT, the present invention computes feature depth using calibrated geometric disparity between stereo image pairs. This provides: targeted three-dimensional positional data; reduced computational complexity; faster processing; and compatibility with inline production systems. The system thus achieves meaningful 3-D metrology without requiring rotational scanning or tomographic reconstruction.

Effective pixel pitch normalization: A significant advancement of the present invention is feature-specific magnification compensation using effective pixel pitch normalization derived from calculated depth. This enables true physical defect dimension determination; correction of geometric magnification effects; and reliable acceptance/rejection decisions. Conventional digital radiography does not provide such calibrated depth-based pixel scaling.

Stereo reference frame visualization: The present invention optionally provides dynamic stereo reference frame generation based on inspection geometry parameters. This improves operator interpretation of depth cues while maintaining calibrated geometric consistency.

Industrial throughput advantages over CT: Compared to computed tomography, the present invention: eliminates rotational scanning; reduces acquisition time; reduces computational burden; allows inline or near-inline inspection; uses existing radiographic infrastructure; substantially lowers system cost.

Thus, the present invention provides a technologically advanced intermediate solution that delivers calibrated three-dimensional dimensional accuracy approaching CT capabilities in targeted defect regions, while preserving the speed and simplicity of conventional radiography. Accordingly, the present invention represents a significant technological advancement by integrating: stationary-source stereo radiography; structured geometric calibration; disparity-based depth computation; magnification-compensated dimensional metrology; optional stereo visualization; and automated inspection decision generation into a unified radiographic inspection framework. The present invention accordingly provides dimensional accuracy and depth localization without the complexity, cost, and computational overhead of computed tomography, while substantially improving over conventional systems.

In other words, the present invention provides a stereo radiographic inspection system and method for deriving calibrated three-dimensional positional and dimensional information from stereo radiographic image pairs without requiring volumetric computed tomography reconstruction.

In an embodiment, the present invention provides a radiographic inspection system comprising a penetrating radiation source that can remain stationary during stereo image acquisition and one or more digital radiographic detectors configured to acquire a stereo pair of radiographic images of an object under inspection without repositioning the radiation source. Stereo disparity is generated by controlled relative displacement between the object and the source. This displacement can result from repositioning the radiation source, repositioning the part, repositioning the part and detector, or translating the part past two stationary linear diode arrays positioned at laterally separated locations. In contrast to systems that only reposition the radiation source to obtain different viewing angles. The capability to maintain a stationary source in the present invention improves geometric stability, reduces mechanical complexity, and enhances repeatability of inspection geometry.

In another embodiment, the system of the present invention includes a setup registration device comprising calibration features having known spatial relationships. Stereo images of the setup registration device are used to determine inspection geometry parameters, including at least source-to-detector distance, source-to-object distance, and the location on the detector plane where the radiation beam is normal to the detector plane, the Beam Normal Point (BNP). These parameters establish a calibrated geometric framework for depth computation, magnification compensation, and x and y plane positioning for features (three-dimensional positioning).

Using the calibrated inspection geometry parameters, the system of the present invention identifies corresponding features between the stereo images and computes feature depth based on disparity between corresponding feature positions. Depth calculation is performed using the calibrated source-object-detector relationships rather than solely relying on image coordinate comparison, thereby enabling physically meaningful three-dimensional positional data.

In another embodiment, the present invention determines magnification-compensated dimensional data for detected features. Based on calculated feature depth, an effective image pixel pitch is determined for each feature, enabling determination of true physical dimensions independent of geometric magnification inherent in projection radiography. This feature-specific magnification compensation allows accurate defect size measurement without tomographic reconstruction.

In certain embodiments, the system of the present invention generates a corrected two-dimensional radiographic image in which features are rescaled according to calculated effective pixel pitch. The corrected image provides improved dimensional fidelity while preserving the efficiency and acquisition speed of projection radiography.

In further embodiments, the present invention includes automated inspection analysis. Magnification-compensated dimensional data may be used to determine compliance with predefined inspection acceptance criteria. The system of the present invention optionally generates inspection output reports including feature size, feature location, defect classification, and automated pass/fail determinations.

In another embodiment, the present invention provides a stereo visualization framework in which a stereo reference frame is dynamically generated based on inspection geometry parameters and overlaid onto stereo image pairs to provide enhanced depth cues during stereo viewing. The stereo reference frame is optionally generated uniquely for each inspected object and is derived from calibrated inspection geometry to maintain consistency with computed depth relationships.

In an additional embodiment, the present invention provides computer-implemented methods for processing stereo radiographic image data, including receiving stereo image data, receiving calibrated inspection geometry parameters, determining feature correspondence, computing depth from disparity, calculating effective pixel pitch, and generating magnification-compensated dimensional measurements. These processing steps are optionally implemented in software executed on one or more processors and may be integrated with existing radiographic hardware systems.

The present invention thereby bridges the technological gap between conventional two-dimensional digital radiography and full computed tomography by providing calibrated three-dimensional feature characterization without rotational scanning, volumetric reconstruction, or the associated computational and capital cost burdens of CT systems.

By integrating stationary-source stereo acquisition capability, structured geometric calibration, disparity-based depth computation, magnification-compensated dimensional metrology, optional stereo visualization, automated inspection decision generation and in-motion stereo image acquisition when utilizing two linear diode arrays, the present invention provides a technically advanced, efficient, and cost-effective solution for industrial radiographic inspection.

In an embodiment of the present invention, it provides a radiographic inspection system comprising: a radiation source; one or more digital radiographic detectors configured to acquire a stereo pair of radiographic images of an object under inspection with or without repositioning the radiation source; a processor operatively coupled to the one or more detectors, the processor configured to: identify one or more features of interest in each image of the stereo pair; determine corresponding features between the stereo pair based on image content and known acquisition geometry; calculate a depth location of each corresponding feature based on geometric disparity between the stereo images; and generate three-dimensional positional and sizing data for each feature independent of geometric magnification.

In another embodiment of the radiographic inspection system as disclosed herein, wherein the stereo pair is acquired by shifting the object under inspection relative to the detectors.

In another embodiment of the radiographic inspection system as disclosed herein, wherein the stereo pair is acquired using a scanning linear detector array and relative movement between the object and the detector.

In another embodiment of the radiographic inspection system as disclosed herein, wherein the stereo pair is acquired shifting the radiation source relative to the object and detector.

In another embodiment of the radiographic inspection system as disclosed herein, wherein the stereo pair is acquired using two stationary linear detector arrays and controlled translation of the object past the detector arrays.

In another embodiment of the radiographic inspection system as disclosed herein, wherein the processor employs an artificial intelligence model trained on stereo radiographic data to identify corresponding features between the stereo images, and wherein the artificial intelligence model constrains a correspondence search space based on known inspection geometry.

In another embodiment of the radiographic inspection system as disclosed herein, wherein the processor calculates lateral positional coordinates for each feature using a beam normal point (BNP) and a source-to-detector distance and feature depth.

In another embodiment of the radiographic inspection system as disclosed herein, wherein the processor calculates an effective image pixel pitch for each feature based on the calculated depth location, and wherein the processor determines a true physical size of each feature independent of geometric magnification.

In another embodiment of the radiographic inspection system as disclosed herein, further comprising a setup registration device having known internal features, the setup registration device configured to enable determination of inspection geometry parameters, and wherein the processor determines at least one of a source-to-detector distance, a source-to-object distance, or a beam normal location to the detector plane using images of the setup registration device.

In another embodiment of the radiographic inspection system as disclosed herein, wherein the processor generates a stereo reference frame overlaid on the stereo images to provide visual depth cues, and wherein the stereo reference frame is generated dynamically based on inspection geometry and object dimensions.

In another embodiment of the radiographic inspection system as disclosed herein, wherein the processor generates a corrected two-dimensional radiographic image in which features are rescaled to a common effective pixel pitch, and wherein features exceeding a predefined true-size threshold are highlighted in the corrected two-dimensional image.

In an embodiment of the present invention, it provides a method of radiographic inspection comprising: acquiring a stereo pair of radiographic images of an object using a shifted or stationary radiation source; identifying corresponding features of interest between the stereo images using automated image analysis; calculating a depth location of each feature based on geometric disparity between the stereo images and known inspection geometry; and outputting three-dimensional positional information for the features.

In another embodiment of the method of radiographic inspection as disclosed herein, further comprising calculating an effective image pixel pitch for each feature based on the calculated depth location.

In another embodiment of the method of radiographic inspection as disclosed herein, further comprising rescaling a two-dimensional radiographic image to compensate for geometric magnification.

In another embodiment of the method of radiographic inspection as disclosed herein, further comprising overlaying three-dimensional positional information for the features onto a two-dimensional and/or stereo radiographic image.

In an embodiment of the present invention, it provides a method for calibrating a stereo radiographic inspection system comprising: acquiring stereo radiographic images of a calibration device having known internal feature locations; determining inspection geometry parameters from the images, including at least one of source-to-detector distance, source-to-object distance, or beam normal location on detector plane; and applying the determined inspection geometry parameters to calculate three-dimensional feature locations in subsequent inspections.

In an embodiment of the present invention, it provides a radiographic inspection system comprising: a shifted or stationary penetrating radiation source during stereo image acquisition; one or more digital radiographic detectors configured to acquire a stereo pair of radiographic images of an object under inspection, wherein the stereo pair is acquired by at least one of: (i) shifting the object under inspection, or (ii) shifting the object under inspection and the detector (digitally or physically), or (iii) scanning the object over a pair of linear diode arrays shifting the object and rescanning with the linear diode array relative to the stationary radiation source by a predetermined lateral, (iv) shifting the x-ray source relative to the object and detector or (v) providing two stationary linear detector arrays positioned at laterally separated locations and translating the object under inspection past the linear detector arrays; a setup registration device comprising a plurality of calibration features having known spatial relationships; and at least one processor executing stored software instructions and operatively coupled to the detectors, the processor configured to: determine inspection geometry parameters including at least a source-to-detector distance, a source-to-object distance, and a beam normal location to the detector plane, beam normal point (BNP) using an image of the setup registration device; identify one or more features of interest in each image of the stereo pair; determine corresponding features between the stereo pair using automated image analysis; calculate a depth location of each corresponding feature using disparity between corresponding feature positions and the inspection geometry parameters; and generate three-dimensional positional data and magnification-compensated dimensional data for each feature. In another embodiment of this system, wherein the penetrating radiation source comprises an X-ray source or a gamma radiation source. In another embodiment of this system, wherein the corresponding features determination comprises performing artificial intelligence-based matching. In another embodiment of this system, wherein corresponding features determination comprises performing rule-based matching or deterministic image processing. In another embodiment of this system, wherein the processor calculates lateral positional coordinates for each feature using the beam normal location to the detector plane (BNP) and magnification relationships derived from the inspection geometry parameters. In another embodiment of this system, wherein the processor calculates an effective image pixel pitch for each feature based on the calculated depth location, and wherein the processor determines a true physical size of each feature using the effective image pixel pitch. In another embodiment of this system, wherein the setup registration device is reusable across multiple inspections. In another embodiment of this system, wherein the inspection geometry parameters are alternatively determined using image-only calibration techniques. In another embodiment of this system, wherein the processor generates a corrected two-dimensional radiographic image in which features are rescaled to a common effective pixel pitch, and wherein the processor highlights features exceeding predefined true physical dimension thresholds. In another embodiment of this system, wherein the processor performs automated inspection acceptability determinations based on the magnification-compensated dimensional data. In another embodiment of this system, further comprising generation of a stereo reference frame dynamically derived from the inspection geometry parameters and overlaid on stereo images for stereo visualization, and wherein the stereo reference frame is generated uniquely for each inspected object. In another embodiment of this system, wherein the stereo reference frame comprises at least one projected grid reference, horizon reference, or vanishing point reference.

In an embodiment of the present invention, it provides a method of radiographic inspection comprising: acquiring a stereo pair of radiographic images of an object using a shifted or stationary radiation source, wherein the stereo pair is acquired by either a stationary or shifted the object and at least one detector relative to the radiation source or translating the object past two stationary linear detector arrays; acquiring stereo calibration images of a setup registration device having calibration features with known spatial relationships; determining inspection geometry parameters including at least source-to-detector distance, source-to-object distance, and beam normal location to the detector plane (BNP) using the calibration images; identifying corresponding features between the stereo images using automated image analysis; calculating a depth location of each feature using disparity between corresponding feature positions and the inspection geometry parameters; determining magnification-compensated dimensional data for each feature; and outputting three-dimensional positional data and dimensional data for the features. In another embodiment of this system, further comprising generating a corrected two-dimensional radiographic image that compensates for geometric magnification using calculated feature depth. In another embodiment of this system, further comprising performing automated acceptance or rejection of inspected objects based on true physical feature dimensions.

In an embodiment of the present invention, it provides a computer-implemented method for processing stereo radiographic image data comprising: receiving stereo radiographic image data comprising a first radiographic image and a second radiographic image; receiving inspection geometry parameters derived from calibration images of a setup registration device or image-only calibration techniques; identifying corresponding features between the first and second radiographic images using automated image analysis; calculating a depth location for each corresponding feature using disparity between feature positions and the inspection geometry parameters; calculating an effective pixel pitch associated with each feature using the calculated depth location; and generating magnification-compensated dimensional measurements and three-dimensional positional data for the corresponding features. In another embodiment of this system, further comprising generating a corrected two-dimensional radiographic image in which features are rescaled to compensate for geometric magnification.

In an embodiment of the present invention, it provides a stereo visualization method for radiographic inspection comprising: receiving a stereo pair of radiographic images of an inspected object; receiving inspection geometry parameters associated with acquisition of the stereo pair; dynamically generating a stereo reference frame based on the inspection geometry parameters and object characteristics; and overlaying the stereo reference frame onto each image of the stereo pair to provide depth visualization cues for stereo viewing. In another embodiment of this system, wherein the stereo reference frame is not displayed on non-stereo two-dimensional radiographic images.

In an embodiment of the present invention, it provides a computer-implemented method for generating an inspection output for a radiographic inspection comprising: receiving stereo radiographic image data associated with an inspected object; determining three-dimensional positional data for one or more detected features using calibrated inspection geometry parameters; determining dimensional characteristics of the detected features using depth-based geometric magnification compensation; and generating an inspection output report including at least one of feature size, feature location, feature classification, or inspection acceptability determination. In another embodiment of this system, wherein generating the inspection output report includes determining whether the inspected object satisfies predefined acceptance criteria based on true physical dimensions of detected features. In another embodiment of this system, wherein generating the inspection output report includes classifying detected features into defect categories using automated image analysis. In another embodiment of this system, wherein the inspection output report includes graphical visualization of detected features overlaid on a radiographic image. In another embodiment of this system, wherein the inspection output report includes automated pass or fail determinations for the inspected object.

In an embodiment of the present invention, it provides a radiographic inspection system, comprising: a penetrating radiation source that can be shifted or remain stationary during acquisition of a stereo image pair; at least one digital radiographic detector system configured to acquire a first radiographic image and a second radiographic image of an object under inspection with or without repositioning the radiation source, wherein the stereo image pair is acquired by establishing relative lateral displacement between the object and the source or by translating the object past two laterally separated stationary linear detector arrays; a calibration structure having a plurality of features with known spatial relationships; and at least one processor configured to: (a) determine inspection geometry parameters including at least source-to-detector distance, source-to-object distance, and beam normal location to the detector plane (BNP) using images of the calibration structure or image-based geometric estimation; (b) identify corresponding features between the first and second radiographic images; (c) compute a depth location of each corresponding feature using disparity between feature positions in the stereo image pair and the inspection geometry parameters; and (d) determine magnification-compensated dimensional data for the corresponding feature based on the computed depth location.

In an alternate embodiment of the present invention, it provides a radiographic inspection system, comprising: a penetrating radiation source; at least one detector; a calibration structure having a plurality of features with known spatial relationships; and a computer system for detector control, detector calibration, image processing, image presentation, motion control for acquisition of parallax offset stereo pair images, a linear motion system, a monitor, wherein the computer system has at least one processor configured to: (a) determine inspection geometry parameters including at least source-to-detector distance, source-to-object distance, and source normal location using images of the calibration structure or image-based geometric estimation; (b) identify corresponding features between the first and second radiographic images; (c) compute three-dimensional location of each corresponding feature using disparity between feature positions in the stereo image pair and the inspection geometry parameters; and (d) determine magnification-compensated dimensional data for the corresponding feature based on the computed depth location.

In another embodiment of the radiographic inspection system as disclosed herein, wherein the radiation source comprises a group selected from an X-ray source and a gamma radiation source.

In another embodiment of the radiographic inspection system as disclosed herein, wherein the stereo pair images are acquired by a controlled translation of the object past two linear detector arrays.

In another embodiment of the radiographic inspection system as disclosed herein, wherein the stereo pair is acquired by a means of image acquisition selected from a group selected from a means of image acquisition involving shifting the object, shifting both the object and detector relative to the radiation source, shifting the radiation source, and a means of image acquisition using two stationary linear detector arrays and controlled translation of the object past the two stationary linear detector arrays.

In another embodiment of the radiographic inspection system as disclosed herein, wherein the corresponding features are identified by means selected from means where the corresponding features are identified using artificial intelligence-based matching and means where the corresponding features are identified using rule-based or deterministic image processing.

In another embodiment of the radiographic inspection system as disclosed herein, wherein the processor calculates an effective pixel pitch for the corresponding feature based on the computed depth location, and a true physical feature size is determined using the effective pixel pitch.

In another embodiment of the radiographic inspection system as disclosed herein, wherein the calibration structure is reusable across multiple inspections.

In another embodiment of the radiographic inspection system as disclosed herein, wherein the inspection geometry parameters are determined without a physical calibration structure using image-only calibration techniques.

In another embodiment of the radiographic inspection system as disclosed herein, wherein the processor generates a corrected two-dimensional radiographic image in which geometric magnification effects are compensated using the computed depth.

In another embodiment of the radiographic inspection system as disclosed herein, further comprising automated inspection acceptability determination based on the magnification-compensated dimensional data.

In another embodiment of the radiographic inspection system as disclosed herein, wherein the stereo radiographic inspection image is displayed with visible depth references/frames.

In an embodiment of the present invention, it provides a method of radiographic inspection, comprising: acquiring a stereo pair of radiographic images of an object using a penetrating radiation source; determining inspection geometry parameters using either a calibration structure having known spatial relationships or image-based calibration; identifying corresponding features between the stereo images; calculating a depth location for each feature using disparity between corresponding feature positions and the inspection geometry parameters; calculating magnification-compensated dimensional data for each feature based on the depth location; and outputting three-dimensional positional data.

In another embodiment of the method of radiographic inspection as disclosed herein, wherein the penetrating radiation source is a stationary or shifted penetrating radiation source.

In another embodiment of the method of radiographic inspection as disclosed herein, wherein the method optionally outputs dimensional measurements for the feature.

In another embodiment of the method of radiographic inspection as disclosed herein, wherein the acquiring the stereo pair is by a means of image acquisition selected from a group selected from a means of image acquisition involving both the object and at least one detector relative to the radiation source, a means of image acquisition involving shifting the object relative to the radiation source, a means of shifting the radiation source relative to the object and detector, and a means of image acquisition using two stationary linear detector arrays and controlled translation of the object past the two stationary linear detector arrays.

In another embodiment of the method of radiographic inspection as disclosed herein, further comprising generating a corrected two-dimensional radiographic image using depth-based magnification compensation.

In another embodiment of the method of radiographic inspection as disclosed herein, further comprising performing automated pass or fail determination based on true physical feature dimensions.

In another embodiment of the method of radiographic inspection as disclosed herein, further comprising a stereo reference frame/guide to the stereo radiographic image.

In an embodiment of the present invention, it provides a computer-implemented method for processing stereo radiographic images and data comprising: receiving a first radiographic image and a second radiographic image forming a stereo pair; receiving inspection geometry parameters associated with acquisition of the stereo pair; identifying corresponding features between the first and second radiographic images; computing feature depth using disparity between feature positions and the inspection geometry parameters; determining effective pixel pitch for each feature based on computed depth; and generating magnification-compensated dimensional measurements and three-dimensional positional data for the features.

In another embodiment of the computer-implemented method for processing stereo radiographic image data as disclosed herein, further comprising generating a corrected two-dimensional radiographic image based on the effective pixel pitch.

In another embodiment of the computer-implemented method for processing stereo radiographic image data as disclosed herein, wherein the inspection geometry parameters are derived from either images of a calibration structure or image-only geometric estimation.

In another embodiment of the computer-implemented method for processing stereo radiographic image data as disclosed herein, further comprising generating a stereo reference frame/guide based on inspection geometry parameters.

In an embodiment of the present invention, it provides a stereo visualization method comprising: receiving a stereo pair of radiographic images; receiving inspection geometry parameters associated with acquisition of the stereo pair; dynamically generating a stereo reference frame based on the inspection geometry parameters; and overlaying the stereo reference frame onto the stereo pair to provide depth visualization cues.

In another embodiment of the stereo visualization method as disclosed herein, wherein the stereo reference frame comprises at least one projected grid providing visual reference for a horizon reference and/or a vanishing point reference.

In another embodiment of the stereo visualization method as disclosed herein, wherein the stereo reference frame is generated uniquely for each inspected object.

In another embodiment of the stereo visualization method as disclosed herein, wherein the stereo reference frame is not displayed on non-stereo two-dimensional radiographic images.

In an embodiment of the present invention, it provides a computer-implemented method for generating an inspection output comprising: receiving stereo radiographic image data; determining three-dimensional feature location using calibrated inspection geometry parameters; determining magnification-compensated physical feature dimensions; comparing the physical feature dimensions to predefined inspection criteria; and generating an inspection output including at least one of feature size, feature location, defect classification, or pass/fail determination.

In another embodiment of the computer-implemented method for generating an inspection output as disclosed herein, wherein the defect classification is performed using artificial intelligence.

In another embodiment of the computer-implemented method for generating an inspection output as disclosed herein, wherein the defect classification is performed using rule-based processing.

In another embodiment of the computer-implemented method for generating an inspection output as disclosed herein, wherein the inspection output includes a graphical overlay of detected features on a radiographic image.

The present invention provides a radiographic inspection system capable of deriving calibrated three-dimensional positional information from stereo radiographic image pairs without requiring computed tomography reconstruction.

The present invention provides a stereo radiographic acquisition framework in which a penetrating radiation source remains stationary during stereo image acquisition, thereby improving geometric stability, reducing mechanical complexity, and enhancing repeatability relative to systems requiring source repositioning.

The present invention provides a radiographic inspection system capable of determining inspection geometry parameters, including source-to-detector distance, source-to-object distance, and beam normal location to the detector plane (BNP), using a setup registration device having calibration features with known spatial relationships.

The present invention is used to compute depth location of internal features using disparity between corresponding features in stereo radiographic images in combination with calibrated inspection geometry parameters.

The present invention is used to determine magnification-compensated dimensional measurements for detected features, thereby enabling determination of true physical defect size independent of geometric magnification effects inherent in projection radiography.

The present invention provides effective pixel pitch normalization based on calculated feature depth, allowing radiographic images to be rescaled for accurate dimensional interpretation.

The present invention generates corrected two-dimensional radiographic images in which geometric magnification effects are compensated, thereby improving inspection accuracy without requiring volumetric reconstruction.

The present invention provides automated inspection decision-making based on magnification-compensated dimensional data, including pass/fail determinations according to predefined acceptance criteria.

The present invention provides a stereo reference frame dynamically generated from inspection geometry parameters to enhance stereo visualization and operator interpretation of depth information.

The present invention provides a stereo radiographic inspection framework suitable for high-throughput industrial environments, including aerospace component manufacturing, additive manufacturing validation, pipeline inspection, and energy infrastructure inspection.

The present invention provides a system that achieves three-dimensional positional localization comparable to volumetric inspection methods in targeted regions of interest and compensates two-dimensional projected images for geometric source magnification while avoiding the acquisition time, computational burden, and capital cost associated with computed tomography systems.

The present invention provides a software-centric implementation capable of integration with existing radiographic hardware infrastructure, thereby enabling retrofit deployment and cost-effective adoption.

The present invention provides a calibration methodology that is reusable across inspections and adaptable to different inspection geometries.

The present invention bridges the technological gap between conventional two-dimensional digital radiography and full computed tomography by providing calibrated three-dimensional positional localization and scaling of projected images for geometric source magnification without requiring rotational scanning or tomographic reconstruction.

The invention will be further explained by the following Examples, which are intended to be purely exemplary of the invention and should not be considered as limiting the invention in any way.

### EXAMPLES

The following example provides exemplary embodiments of the implantable devices and sealing halo units of the present invention.

In the present invention, stereo radiographic image acquisition refers to acquisition of traditional stereo image pairs required shifting the x-ray source parallel to the x-ray detector, commonly film. FIG. 1 presents five alternative acquisition techniques for stereo image pairs. One is a traditional method utilizing source translation parallel to the detector plane, illustrated in panel (E) of FIG. 1. The remaining four do not translate the heavy and difficult to align source, illustrated in panel (A) to (D) of FIG. 1. The first of these techniques shifts the part or part and detector and leaves the x-ray source stationary. The second shifts only the part and, since the detector provides a digital image, shifting the detector is simulated by providing a new zero reference point for the starting point of the image. This requires that the area of interest in the part is within the detectors imaging area before and after shifting the part. The third technique uses a scanning linear detector array. The first image is acquired with a stationary part and a scanning LDA. For the second image, the part is shifted and then kept stationary while the LDA scans the repositioned part. The fourth technique uses two stationary LDAs and translates the part past both LDAs at a uniform rate.

In the present invention, Artificial Intelligence (AI) is trained utilizing stereo-pair images and is used to identify and locate the positions of the corresponding items of interest in both images. AI is provided with radiographic setup geometry (source to detector, source to object, and the location on the detector plane where the radiation beam is normal to the detector plane, the Beam Normal Point (BNP), as well as inspection part geometry and stereo shifting/scanning setup as appropriate (i.e. relative technique information for techniques 1 through 4). Unlike AI used for common radiographic image interpretation, AI in the present invention has access to two images to support identification and location of items of interest. The stereo technique limits the area of search when the AI is looking for an associated flagged area in the second stereo pair image. FIG. 2 shows simulated AI flagged images. The specific stereo radiographic technique provides limits to the difference in the relative image location from one image to the next. This, along with relative image contrast and shape information, improves the confidence for AI location information. In the present invention, AI, as a minimum, optionally provides image positional information for an item of interest on each of the two corresponding stereo image pairs.

In the present invention, for three-dimensional location, projected image positional information is acquired by AI and is used to calculate the three-dimensional location for a given item of interest. Stereo techniques calculate the distance (depth) of an indication from the detector (or source) by measuring the locations of the shadow graph image for an item of interest in both images. This image difference is then used to calculate the distance of an item of interest from the source or detector (depth).

Radiographic setup parameters (distances from source to detector and the source to the part) and distance the part was shifted are required parameters for the depth calculation. FIG. 3 identifies the process for gathering depth information for a flagged item for the traditional acquisition techniques and techniques identified as 1, 2 and 3. For all techniques, additional setup information is required to the x and y positions for a flagged item. This involves locating the beam normal point location to the detector plan (BNP). Once the depth and beam normal point are known, x, y and z positional information can be calculated for the flagged items. As shown in FIG. 3, for calculating the relative depth (z-axis) location using a 2-D or Scanning LDA detector, when the known values for SDD (Source to Detector distance) is 60, SOD (Source to Object (centerline) distance) is 30, and plot thickness is 7, Flaw image shift=2*2.62=4.52, Delta_x=0.52 measured on image, i.e., when images are recentered −4.52−2*Shift=0.52, Delta_x+Shift*Mag_center=4.52, 4.52/Shift_distance=2.26x, so then, 60/2.26=26.5 is the distance from Source, and 30−26.5=3.5 is the distance from center towards Source, hence, the depth of item centerline is 3.5. It is noted that the stereo images shown shifted the second image back to align the center of the object at the viewing screen. A Setup Registration Device (SRD) can be used to verify and/or locate the x-ray beam normal point and geometric setup of the x-ray machine, part scanner and detector. An example for an SRD and its use is presented later in this application.

For the two stationary LDAs and the moving part, technique 4, the depth calculation (Z-axis) is different. For this technique, the two LDAs basically provide just two lines of sight taken from different angular positions from the source. (This does not provide 2-D images with image magnification factors both in the x and y planes.) In this case, magnification of the image only applies to the direction parallel to the LDA (y-axis). For the direction parallel to the part movement (x-axis), the scaling is constant and is based on the scanning rate of the part (e.g. inches per second) and the sampling rate of the LDAs. The parameters required for calculating the depth (z-axis) are the difference in image positions for an item of interest in the image from LDA1 compared to the image from LDA2, the separation between the LDAs and the source to detector distance. FIG. 4 provides an example for calculating the depth for a two stationary LDAs acquisition. The x-axis information is taken from the scanning index, the source to detector distance, and any specified x-axis reference point. The y-axis information requires a known depth (z-axis) and involves the source magnification noted previously and beam normal point. The y-axis calculation is the same as that used for 2-D detectors. As shown in FIG. 4, for calculating the relative depth (z-axis) location using two stationary LDAs as discussed above, when the known values for SDD (Source to Detector distance) is 60, SOD (Source to Object (centerline) distance) is 30, and the Distance between the two LDAs or Delta_LDA is 2, Delta_x=0.40 measured on image, then depth=((Delta_x)/Delta_LDA)*SDD, so, depth=((0.40)/2)*60=12, which is the distance from Source.

In the present invention, for dimensional and distance measurements, the size and shape of the projected shadowgraph and the projected positional information is used to calculate the effect of source magnification on the shadowgraph image and therefore provide more definitive information relative to the item of interest (e.g. diameter of a void, height (y-dimension) and width (x-dimension) and distance between indications.

Dimensional information is provided for each item of interest. This information is optionally printed and/or overlayed on a single shadowgraph image. The information is also optionally presented on the stereo image and can be presented with same perceived depth as the item of interest. FIG. 5 provides an example for the type of information that can be provided. It shows a stereo anaglyph image with 3-D projected 3-D dimensional location information, connecting 3-D projected lines and distance measurements between several items of interest, or in other words, the said stereo image with location information, distance between indications, and connecting 3-D perspective lines between indications. Further, labels will be displayed with appropriate parallax for the depth of the indications. For clarity, the labels displayed in FIG. 5 are not presented with stereo pairs. This stereo anaglyph image has an overlayed 3-D reference grid (SRF) to assist a viewer with visual depth and positional registration for items of interest.

In the present invention, there are several system setup parameters that should be known in order to acquire accurate 3-D dimensional information. These includes source to detector (SDD) and source to object distances (SOD) and the x-ray beam normal point location relative to the detector and/or detectors plane. In addition, the scanning or shifting direction of the object or shifting direction of the source should run parallel to the detector plane.

Careful setup and measurement of the system positioning and alignment can establish these parameters. However, it optionally also is advisable to run a verification check using a part, such as a Setup Registration Device (SRD), with known size and location of items of interest (e.g. holes or spheres). FIG. 6 shows an example of an SRD. The size of the SRD is known and the position and size of each hole or sphere is known. The SRD is positioned with its front surface parallel to the detector and the scan direction. One image is acquired of the SRD. The resulting projected image from the SRD can be used to confirm the required image setup parameters. To do so, the Device is placed parallel to the Detector, the Device is scanned parallel to the Detector, such that the projected images from the Beam Centerline alignment holes can be used to confirm the location of the beam centerline, where the Device is moved till the holes align; and the projected image distance is measured between the top and bottom holes respectively, and these measurements are used to calculate SDD and SOD. For 2-D and scanning LDA detectors, FIG. 7 provides an example for acquiring SDD and SOD setup distances from an SRD. To do so, geometry setup parameters are needed for accurate depth calculations, where these parameters are controlled and measured when positioning the source, object and detector, and can also be confirmed using the SRD. For calculations, distance_top_X=13.32, distance_bottom_X=10.90, pixel_pitch=0.010, hole_spacing_X=6, hole_spacing_Z=6, and then using the formula: SOD_top=((distance_bottom_X)*(hole_spacing_Z))/((distance_top_X) (distance_bottom_X))=27.025. Next, using the formula: SOD_bottom=SOD_top+6=33.025. Next, using the formula: SDD=((distance_top_X)/(hole_spacing_X))*(SOD_top)=59.995. FIG. 8 provides an example for acquiring the beam normal point location for x and y axes for 2-D detectors and scanning LDAs. FIG. 9 provides an example for acquiring the same information, i.e., SDD and SOD information and beam normal point location for an image of the SRD acquired with two stationary LDAs and a translated part. The LDA SRD Setup Geometry calculation are illustrated here, where for the SDD and SOD calculation, the geometric setup is such that the Sphere_distance_Y=6, Detector_pixel=0.010, to measure Y-axis positions, Source_side=1500, Detector_side_D=1000. The formula for Mag_source_side=(1500 detector_pixel)/(Sphere_distance_Y)=2.5; and the formula for Mag_detector_side=(1000-detector_pixel)/(Sphere_distance_Y)=1.66667. Next, for SOD to source side calculations, the formula used is SOD_source_side=((Mag_detector_side)/((Mag_source_side)−(Mag_detector_side)))*(Sphere_distance_Y)=12. Next, the formula for SDD=(Mag_source_side)*(SOD_source_side)=30. Next, the formula for SDD_detector_side=(SOD_source_side)+(Sphere_distance_Y)=18. Next, the formula for SOD_center=(SOD_source_side)+((Sphere_distance_Y)/2)=15. Further, for LDA detector x-axis offset, to measure x-axis positions, Sphere_distance_X=6, X position offset between top and bottom spheres (Top=source side-Bottom=detector side). When Top_sphere_X=1743, Bottom_sphere_X=1623, the formula for X_image_offset=((Top_sphere_X)−(Bottom_sphere_X))*Image_pixel. Next, the formula for θ=atan ((X_image_offset)/(Sphere_distance_X))=0.1 radians, θ/deg=5.711. Next the formula for LDA_offset=SDD*tan(θ)=3. Next, calculate the line from the top sphere image to the bottom sphere image to find the Y-intercept point for the lines. Here, Image size=2048*2048, Detector pixel pitch=0.010, Y-intercept=1224, Mag image=2X, then, using the formula, Y-axis beam offset=(1224−(2048/2))*(pixel pitch/Mag image)=−1.

In the present invention, stereo images are commonly taken of scenic areas. These images incorporate familiar objects that allow a viewer to readily extract relative depth information from the stereo image. These references include buildings, trees, people, etc. These objects generally have a predictable size and their size relative to that of other objects in the image can be used to assist the viewer to properly register their relative depth. For radiographic shadowgraph images, in many, if not most cases, there may not be any adequate references in the image. Stereo Reference Frames (SRFs) are applied to each of the stereo pair images and are used to provide visual size and depth references for the viewer. The SRF is calculated for each specific application based on the object radiographed and the specific stereo acquisition setup parameters. The SRF provides a viewer guide for visualizing the horizon line and vanishing point for the stereo radiographic image similar to buildings aligning a street screen. Examples for SRFs are shown in FIG. 5 and in FIG. 10 to FIG. 13. Stereo anaglyphs with and without SRFs and some 2-D projection radiographic images are provided to illustrate the additional positional visual information that is possible with 3-D Stereo Augmented Radiography when compared with conventional 2-D projection radiography.

In the present invention, for 2-D radiographic image interpretation enhancements, 2-D radiographic image interpretation benefit from the information derived from stereo augmented radiography. These benefits include: annotating and/or overlaying 2-D images with 3-D positional information for flagged indications (see FIG. 14); highlighting any flagged indications that exceed a certain size and/or are located in a particular area (e.g. within a certain distance from the OD and/or ID of a part). As illustrated in FIG. 14, 2-D radiographic mage highlighting flagged indications that are equal to or exceed the 2-2T penetrameter hole diameter. And, indications closer to the detector that the penetrameter have hole diameters with larger effective image pixel pitch and therefore appear smaller. FIG. 14 highlights (white rings) any indications that are equal to or greater than the 2-2T penetrometer hole irrespective of their distance to the source (geometric magnification-effective image pixel pitch); duplicating the 2-D image and rescaling all indications to the same effective image pixel pitch independent of their respective geometric magnification differences (see FIG. 15). In FIG. 15, all indications rescaled to the same effective image pixel pitch (set to match the effective image pixel pitch at the penetrameter location). This can also be applied to stationary LDA images to equate the effective image pixel pitch for the x and y axes for both 2-D and stereo images (see FIG. 16). In FIG. 16, for the initial 2-D LDA image, the image size for each void (x and y mag) varies. Some circular voids appear elliptical. (LDA scan sync), while for the adjusted 2-D LDA image, the image size for all voids is the same. (Image of flagged voids are compensated for depth and LDA scan settings. All the voids are the same size and after image adjustment based on depth, their images are all the same size. Initial image size and shape vary based on its position (depth) and LDA scanning parameters. Next, since the depth is known, adjusted images can be compensated for depth and LDA scanning parameters. Further, the images obtained from a stationary LDA have different x and y scaling factor, resulting in circular void images appearing not as circles but as ellipses.

Thus, the present invention provides that there are significant advancements that are applied to stereo radiography as disclosed herein. These advancements make use of modern tools such as computer-controlled positioners, digital x-ray detectors (DR), artificial intelligence (AI), computer image processing, stereo image monitors, virtual reality (VR) headsets, etc. As discussed before, these advancements before the present invention's disclosure have largely been ignored by the industrial radiographic committee in favor of computer tomography (CT). However, conventional CT systems are expensive and CT data acquisition and interpretation is generally slow, showing a problem and need in the art. Furthermore, for many applications, CT is not applicable (e.g. parts are too cumbersome, too numerous to inspect, too expensive to inspect, etc.). As a result, traditionally, a significant portion of radiographic inspections are performed with 2-D digital radiography (DR). To address the need and problems as enlisted above, stereo radiography as disclosed in the present invention, employing updated tools as disclosed herein, provide 3-D data with minimum additional cost and time when compared with common 2-D digital radiography inspections. The present invention further provides a stereo radiographic process, employing modern advancements in DR, AI, computer position controllers, computer image and data processing, etc. The present invention also discloses visual stereo reference frames to assist a viewer with 3-D visual depth registration for a stereo image and a setup registration device to assist with the stereo system alignment and 3-D location of anomalous conditions.

The stereo radiographic inspection system and methods disclosed in the present invention herein are applicable to a wide range of industrial, manufacturing, infrastructure, and safety-critical inspection environments where internal defect detection, dimensional verification, or structural integrity assessment is required.

The present invention is particularly advantageous in applications requiring three-dimensional positional awareness and true physical dimensional measurement without the cost, time, or computational burden associated with computed tomography systems.

Aerospace and defense applications: In aerospace manufacturing and maintenance environments, components such as turbine blades, structural brackets, airframe joints, composite panels, fastener regions, and welded assemblies require rigorous non-destructive testing (NDT). The present invention enables: depth localization of internal defects such as porosity, inclusions, cracks, and lack-of-fusion regions; true dimensional measurement of internal voids and discontinuities; magnification-compensated defect sizing; and automated acceptance determination based on aerospace standards. The system and method of the present invention are optionally deployed in production lines, maintenance depots, or laboratory settings. Compared to computed tomography systems, the present invention enables faster throughput and reduced capital expense while providing calibrated three-dimensional feature characterization.

Additive manufacturing: Additive manufacturing processes such as powder bed fusion, directed energy deposition, and binder jetting produce complex internal geometries that frequently require inspection for porosity, incomplete fusion, internal voids, or structural inconsistencies. The present invention enables: depth-resolved defect identification within complex internal geometries; true physical sizing of internal porosity; dimensional validation of lattice structures; and high-throughput inspection of printed components. Because additive manufacturing environments often require rapid inspection feedback, the present invention provides a practical alternative to CT-based inspection while maintaining improved dimensional reliability relative to conventional 2D radiography.

Pipeline and energy infrastructure: Inspection of pipeline welds, pressure vessels, and structural components in oil, gas, and energy industries commonly relies on radiographic testing. The present invention enables: depth determination of weld defects; improved characterization of lack-of-penetration defects; accurate sizing of inclusions or voids; and automated pass/fail evaluation based on code requirements. In field-deployable embodiments utilizing gamma radiation sources, the system of the present invention is optionally integrated into mobile inspection platforms without requiring rotational CT systems.

Castings and foundry inspection: Industrial castings frequently contain internal porosity, shrinkage cavities, inclusions, and dimensional irregularities. The present invention enables: depth localization of internal casting defects; magnification-compensated dimensional measurement; automated defect classification; and inline inspection compatibility using dual linear detector arrays. This enables foundry operations to perform enhanced inspection without transitioning to full CT infrastructure.

Automotive and heavy manufacturing: Automotive components such as engine blocks, transmission housings, structural weldments, and safety-critical assemblies require high-throughput inspection. The present invention supports: inline stereo radiographic acquisition; magnification-compensated dimensional metrology; automated decision generation; and reduced inspection cycle time relative to CT systems.

Defense and security applications: The present invention is optionally used in defense-related inspection scenarios including: rocket motor inspection, ammunition and fuze inspections; explosive device evaluation; and structural integrity verification of defense hardware. The ability of the present invention to provide depth characterization without rotational scanning enhances safety and speed.

Retrofit and software-based deployment: Because the present invention is optionally implemented primarily through software processing of stereo image data, it may be deployed as: an upgrade to existing digital radiography systems; a software module integrated into inspection workstations; and a cloud-based processing system receiving stereo image data from remote facilities. This flexibility of the present invention allows cost-effective adoption across industries.

The present invention provides significant technical advancements over conventional two-dimensional digital radiography and offers substantial efficiency advantages relative to computed tomography systems. (i) Stationary source geometry: By maintaining a stationary penetrating radiation source during stereo acquisition, the system: improves geometric repeatability; reduces mechanical complexity; enhances calibration stability; and reduces alignment error risk. This differs from prior stereo systems that reposition the radiation source, which can introduce geometric inconsistency. (ii) In particular the dual stationary LDA application allow for the continuous acquisition of stereo images, no need to stop and shift a part, as well as inspection of very long parts. (iii) Integrated geometric calibration framework: The use of a setup registration device (SRD) or image-based calibration to determine inspection geometry parameters provides: accurate determination of source-to-detector distance; accurate determination of source-to-object distance; beam normal point location centerline characterization; and stable geometric mapping between image space and physical space. This structured calibration framework enables depth computation grounded in known physical geometry. (iv) Disparity-based depth computation without volumetric reconstruction: The present invention computes depth for identified features using calibrated geometric disparity between stereo images without reconstructing a full voxel volume. This provides: reduced computational complexity; faster processing; lower hardware requirements; and suitability for high-throughput industrial environments. Unlike CT, the system of the present invention does not require rotational acquisition or reconstruction of volumetric datasets. (v) Feature-specific effective pixel pitch normalization: A significant technical advancement of the present invention is the determination of effective pixel pitch based on calculated feature depth. This enables: compensation for geometric magnification effects; accurate true physical defect sizing; elimination of depth-dependent measurement distortion; and reliable dimensional metrology using projection images. Conventional digital radiography does not provide feature-specific magnification compensation based on calibrated depth. (vi) Corrected two-dimensional image generation: The present invention optionally generates corrected two-dimensional radiographic images in which magnification effects are compensated. Advantages of this aspect of the present invention include: improved visual interpretability; dimensional accuracy in 2-D representation; reduced operator ambiguity; and retention of projection-based workflow simplicity. (vii) Automated inspection decision support: The integration of magnification-compensated dimensional data into inspection decision logic in the present invention provides: automated pass/fail determination; reduced operator subjectivity; increased repeatability; and improved compliance with inspection standards. (viii) Optional stereo reference frame visualization: Dynamic generation of a stereo reference frame (SRF) in the present invention provides enhanced depth perception while remaining consistent with calibrated geometry. This improves: operator spatial awareness; interpretation of depth relationships; and inspection efficiency. (ix) Cost and throughput advantages over CT: Compared to computed tomography systems, the present invention: eliminates rotational scanning mechanisms; reduces acquisition time; reduces computational reconstruction burden; reduces capital cost; enables inline production integration; and uses existing radiographic infrastructure. The present invention thus provides an intermediate technological solution that bridges the gap between conventional 2-D radiography and full CT. (x) Software-centric implementation: Because key functionality may be implemented in software, the present invention provides: upgrade capability for existing radiographic systems; flexible deployment architectures; scalability across facilities; and reduced hardware dependency. (xi) Industrial scalability: The present invention is adaptable across: laboratory inspection environments; production-line inspection systems; field-deployable mobile radiography units; cloud-based processing infrastructures. Collectively, the present invention therefore provides a technically advanced stereo radiographic inspection framework that achieves calibrated three-dimensional feature localization and true dimensional measurement without the acquisition complexity, cost, and computational burden associated with computed tomography systems, while substantially improving over conventional 2-D digital radiography.

It will be apparent to those skilled in the art that various modifications and variations can be made in the practice of the present invention without departing from the scope or spirit of the invention. Other embodiments of the invention will be apparent to those skilled in the art from considering of the specification and practice of the invention. It is intended that the specification and examples be considered as exemplary only, with a true scope and spirit of the invention being indicated by the following claims.

What is claimed is:

1. A radiographic inspection system, comprising:
a penetrating radiation source;
at least one detector;
a calibration structure having a plurality of features with known spatial relationships; and
a computer system for detector control, detector calibration, image processing, image presentation, motion control for acquisition of parallax offset stereo pair images, a linear motion system, a monitor, wherein the computer system has at least one processor configured to:
(a) determine inspection geometry parameters including at least source-to-detector distance, source-to-object distance, and source normal location using images of the calibration structure or image-based geometric estimation;
(b) identify corresponding features between the first and second radiographic images;
(c) compute three-dimensional location of each corresponding feature using disparity between feature positions in the stereo image pair and the inspection geometry parameters; and
(d) determine magnification-compensated dimensional data for the corresponding feature based on the computed depth location.

2. The radiographic inspection system of claim 1, wherein the stereo pair images are acquired by a controlled translation of the object past two linear detector arrays.

3. The radiographic inspection system of claim 1, wherein the corresponding features are identified by means selected from means where the corresponding features are identified using artificial intelligence-based matching and means where the corresponding features are identified using rule-based or deterministic image processing.

4. The radiographic inspection system of claim 1, wherein the processor calculates an effective pixel pitch for the corresponding feature based on the computed depth location, and a true physical feature size is determined using the effective pixel pitch.

5. The radiographic inspection system of claim 1, wherein the calibration structure is reusable across multiple inspections.

6. The radiographic inspection system of claim 1, wherein the processor generates a corrected two-dimensional radiographic image in which geometric magnification effects are compensated using the computed depth.

7. The radiographic inspection system of claim 1, further comprising automated inspection acceptability determination based on the magnification-compensated dimensional data.

8. The radiographic inspection system of claim 1, wherein the stereo radiographic inspection image is displayed with visible depth references/frames.

9. A method of radiographic inspection, comprising:
acquiring a stereo pair of radiographic images of an object using a penetrating radiation source;
determining inspection geometry parameters using either a calibration structure having known spatial relationships or image-based calibration;
identifying corresponding features between the stereo images;
calculating a depth location for each feature using disparity between corresponding feature positions and the inspection geometry parameters;
calculating magnification-compensated dimensional data for each feature based on the depth location; and
outputting three-dimensional positional data.

10. The method of radiographic inspection of claim 9, further comprising generating a corrected two-dimensional radiographic image using depth-based magnification compensation.

11. The method of radiographic inspection of claim 9, further comprising performing automated pass or fail determination based on true physical feature dimensions.

12. The method of radiographic inspection of claim 9, further comprising a stereo reference frame/guide to the stereo radiographic image.

13. A computer-implemented method for processing stereo radiographic images and data comprising:
receiving a first radiographic image and a second radiographic image forming a stereo pair;
receiving inspection geometry parameters associated with acquisition of the stereo pair;
identifying corresponding features between the first and second radiographic images;
computing feature depth using disparity between feature positions and the inspection geometry parameters;
determining effective pixel pitch for each feature based on computed depth; and
generating magnification-compensated dimensional measurements and three-dimensional positional data for the features.

14. The computer-implemented method for processing stereo radiographic image data of claim 13, further comprising generating a corrected two-dimensional radiographic image based on the effective pixel pitch.

15. The computer-implemented method for processing stereo radiographic image data of claim 13, wherein the inspection geometry parameters are derived from either images of a calibration structure or image-only geometric estimation.

16. The computer-implemented method for processing stereo radiographic images of claim 13, further comprising generating a stereo reference frame/guide based on inspection geometry parameters.
